(19) United States
(12) Patent Application Publication
(10) Pub. No.: US 2015/0295247 A1
(43) Pub. Date: Oct. 15, 2015

(54) Perforated Electrodes for Achieving High Power in Flow Batteries

(71) Applicant: Drexel University, Philadelphia, PA (US)

(72) Inventors: Emin Caglan Kumbur, Philadelphia, PA (US); Christopher Raymond Dennison, Ijamsville, MD (US); Vibha Kalra, Baltimore, MD (US)

(21) Appl. No.: 14/682,238

(22) Filed: Apr. 9, 2015

Related U.S. Application Data
(60) Provisional application No. 61/977,290, filed on Apr. 9, 2014.

(51) Int. Cl. H01M 4/86; H01M 8/20; H01M 4/88; H01M 8/18

(52) U.S. Cl. CPC H01M 4/8626; H01M 8/188; H01M 8/20; H01M 4/88

(57) ABSTRACT

The invention concerns electrodes suitable for use in a redox flow battery, the electrode comprising a plurality of perforations ranging in diameter from 100 μm to 10 cm. The introduction of such perforations is correlated to at least a 10% increase in the power density of the redox flow battery. The invention also concerns methods of making such electrodes and flow batteries having at least one such electrode.

### CROSS REFERENCE TO RELATED APPLICATION

This application claims benefit of U.S. Patent Application No. 61/977,290 which was filed Apr. 9, 2014, the disclosure of which is incorporated herein by reference.

### GOVERNMENT RIGHTS

The subject matter disclosed herein was made with government support under award/contract/grant number NSF CBET 1236466 awarded by the National Science Foundation. The Government has certain rights in the herein disclosed subject matter.

### TECHNICAL FIELD

The invention concerns perforated porous electrodes for high power flow batteries.

### BACKGROUND

Redox flow batteries (RFBs) are emerging as a promising energy storage technology for a broad range of applications. These systems can be used as medium- to large-scale energy storage systems, which are implemented into the electrical grid to store or deliver energy based on demand. Furthermore, this technology can be used for emergency back-up applications to replace diesel generators as uninterruptable power supplies (UPS), or as a stand-alone device to store and deliver electric power in remote areas and micro-grids. The key advantage of flow battery systems is that their energy capacity and power output are decoupled, unlike conventional secondary batteries. Accordingly, the energy capacity of a RFB is determined by the size of the electrolyte reservoirs, while the power output is determined by the electrochemical cell stack (size and number of cells). Other advantages of this technology are fairly long cycle-lifetimes, and the ability to deep-discharge the system without adversely affecting its lifetime. Additionally, the need for cell balancing is eliminated, unlike other secondary battery technologies, because all cells in the stack are supplied from the same storage tanks. Many redox chemistries can be applied in RFB systems, however the ‘all-vanadium’ chemistry is among the most extensively studied due to the advantages of using the same, but differently charged, electrolyte solutions in both half cells.

Although vanadium redox flow batteries (VRFBs) offer a number of advantages, there are several limitations, which hinder their widespread implementation. One disadvantage is the relatively low energy density (40 Wh L⁻¹). Although low energy density is a significant problem for transportation applications, it is not necessarily a major issue for stationary use of a VRFB system, where mass and volume constraints are much less important. Similarly, the power density of a VRFB cell is relatively low compared to lead-acid and lithium-ion batteries. As a result, larger cells must be used to satisfy the power demand, leading to a significant increase in cost. Therefore, any appreciable improvements in power density can yield significant cost-savings, making VRFBs more competitive for grid-scale applications.

The power generated by a VRFB is primarily governed by the electrodes. The electrodes in a VRFB are responsible for hosting the redox reactions and for facilitating the transport of both electrons (through the solid phase) and chemical reactants (through the pore phase) to the reaction sites. Thus, the major factors limiting the power density of a VRFB are kinetic, ohmic, and mass transport losses associated with the electrodes. These factors are primarily determined by surface functionality, electronic resistance, cell architecture and pore structure of the electrode material.

Recently, significant work has been done to improve the electrodes of the VRFB system in order to increase power density and lower system cost. The main emphasis in these studies has been placed on improving the surface area, surface chemistry, pore size distribution and conductivity of the material to improve the reaction kinetics and mass transport ability and reduce the areal series resistance (ASR). Until recently, carbon felts were the most commonly employed electrode materials in VRFBs. Although no catalyst is necessary to facilitate the redox reactions, reaction kinetics still play an important role on system performance, and much work has been done to understand and improve the surface chemistry of carbon felts. To-date, thermal treatments, similar to those described by Sun et al (B. Sun, M. Skyllas-Kazacos, Electrochimica Acta, 37 (1992) 1253-1260), are considered to be the most common practice employed to functionalize carbon felt electrodes and improve their electrochemical performance.

Beyond kinetics, the effective delivery and removal of reactants is another important consideration, which has not been thoroughly studied. Qiu et al. performed pore-scale simulations utilizing XCT-reconstructed electrode morphologies to predict cell performance and localized phenomena inside carbon felt electrodes (G. Qiu, A. S. Joshi, C. R. Dennison, K. W. Knehr, E. C. Kumbur, Y. Sun, Electrochimica Acta, 64 (2012) 46-64; G. Qiu, C. R. Dennison, K. W. Knehr, E. C. Kumbur, S. Ying, Journal of Power Sources, 219 (2012) 223-234). The authors investigated electrodes with porosities ranging from 84.5% to 93.2% and observed lower localized current density and overpotential fields with increased pressure drop for the lower porosity electrodes. Under normal operating conditions, however, the performance of the simulated carbon felt electrodes was not found to be limited by mass transport losses.

Recently, Mench and co-workers utilized carbon paper as an electrode material for VRFBs (D. S. Aaron, Q. Liu, Z. Tang, G. M. Grim, A. B. Papandrew, A. Turhan, T. A. Zawodzinski, M. M. Mench, Journal of Power Sources, 206 (2012) 450-453; M. P. Manahan, Q. H. Liu, M. L. Gross, M. M. Mench, Journal of Power Sources, 222 (2013) 498-502; Q. H. Liu, G. M. Grim, A. B. Papandrew, A. Turhan, T. A. Zawodzinski, M. M. Mench, Journal of the Electrochemical Society, 159 (2012) 1246-1252). These materials are 5× to 10× thinner than carbon felts which enables reduced transport path-lengths for both electrons and ions, resulting in reduced ASR. Moreover, the porosity and pore-size of this material are reduced compared to carbon felt, giving rise to increased specific surface area and thus a higher limiting current density. In a recent study, they demonstrated a VRFB with a peak power of 557 mW cm⁻², which is significantly higher than what had previously been reported in literature. This was accomplished by stacking sheets of carbon paper as the electrodes in each half cell. Additionally, the number of sheets stacked in each half cell was varied in order to study the tradeoff between resistance and surface area. They identified an optimal stack height of three sheets of carbon paper per half-cell, corresponding to an uncompressed thickness of 1230 μm per electrode (D. S. Aaron, Q. Liu, Z. Tang, G. M. Grim, A. B. Papandrew, A. Turhan, T. A. Zawodzinski, M. M. Mench, Journal of Power Sources, 206 (2012) 450-453).

Manahan et al. expanded on this work by modifying carbon paper electrodes with a thin layer of multi-walled carbon nanotubes (CNTs), and then testing the performance of a VRFB with the CNT-treated layer facing either the membrane or flow field side in both half-cells (M. P. Manahan, Q. H. Liu, M. L. Gross, M. M. Mench, Journal of Power Sources, 222 (2013) 498-502). Experiments showed that cell voltage and power density improved the most when the CNT layer was located close to the current collector, especially at the negative side. Based on these findings, they pointed out three important observations: a) the majority of the reactions happen near the current collector, b) CNTs improved electrical contact with the current collectors, and c) the negative electrode is the rate-limiting electrode, which agrees with other studies. Liu et al. further improved the performance of a vanadium flow battery using a no-gap architecture by thermal pre-treatment of carbon paper electrodes in argon and air (Q. H. Liu, G. M. Grim, A. B. Papandrew, A. Turhan, T. A. Zawodzinski, M. M. Mench, Journal of the Electrochemical Society, 159 (2012) 1246-1252). The air treatment showed a greater power density improvement (16% compared to raw material) than argon treatment. This result was attributed to an increase in oxygen containing functional groups, which improved the reaction kinetics at the electrode surface. By optimizing the surface area/chemistry, conductivity of the electrodes, and changing the membrane material, the authors demonstrated a power density of 767 mW cm⁻², which is the highest power density reported to-date.

As these studies show, the most common approach to improving the power density of VRFBs is by increasing the available surface area, decreasing ohmic resistance, and maximizing reaction kinetics. Although significant progress has been achieved through the use of functionalized, high surface area carbon paper electrodes, further improvement of the power density is still necessary to further reduce the cost of these systems. A major aspect of electrode design which has been largely ignored in previous studies is the capability of the electrode to quickly deliver fresh reactant to the available reaction sites. Although the effect of electrode microstructure has previously been explored using numerical simulations, these simulations were applied primarily to carbon felt materials with very high porosity, and relatively large pores. Here, we hypothesize that mass transport is a limiting factor for more dense, high-power carbon paper electrodes, and by improving the accessibility to the available active surface area it is possible to further increase the power density of existing electrode materials.

### SUMMARY

One goal of this work was to better understand the mass transport limitations associated with high power density electrodes (such as carbon paper electrodes), and to identify mitigation strategies which improve the electrolyte accessibility and further enhance power density of these materials. Specifically, we investigated the effects of macro-scale perforations (“transport channels”), on the power density and performance of the porous electrodes in a VRFB system. These transport channels provide facile route for electrolyte to enter and permeate through the electrode, thus improving the supply of reactants to the active surface area of the material.

The resulting invention concerns, inter alia, electrodes suitable for use in a redox flow battery, the electrode comprising a porous electrode having a plurality of perforations, the perforations ranging in diameter from 100 μm to 10 cm. In some embodiments, the electrode has a perforation density of from 10 to 5,000 (holes cm⁻²). It should be noted that the perforations are not limited in geometry. Perforations, for example, can be in the form of holes, slits, channels, voids and the like. Preferred perforations include holes have a diameter from 150 μm to 1 cm.

In certain embodiments, the porous electrode comprises carbon paper. In some embodiments, the porous electrode comprises multiple sheets of paper having a plurality of holes. These multiple sheets may be configured where the perforations are substantially in alignment between the sheets of paper.

Another aspect of the invention concerns flow batteries comprising
a first half-cell comprising:
   a first electrolyte comprising a first redox active material;
   a first electrode in contact with the first electrolyte; and
   a first current collector in contact with the first electrode; and
a second half-cell comprising:
   a second electrolyte comprising a second redox active material; and
   a second electrode in contact with the second electrolyte; a second current collector in contact with the second electrode; and
a separator disposed between the first half-cell and the second half-cell;

wherein at least one of the first or second electrodes is an electrode having perforations as described herein.

In yet another aspect, the invention concerns methods of forming electrodes suitable for use in a redox flow battery, the method comprising forming a plurality of perforations in a porous electrode, the holes ranging in diameter from 100 μm to 10 cm. Suitable electrodes that may be formed by these methods include the perforated electrodes described herein. The method of forming the perforations is not limited. Examples of forming such perforations include use of a laser, punching, milling, drilling, electrical discharge machining, cutting or templating.

### BRIEF DESCRIPTION OF THE DRAWINGS

FIG. 1 presents a schematic of the flow cell setup with laser-perforated electrodes and the laser perforation process. The table summarizes a number of cases studied that have different electrode configuration (i.e., different hole diameter and number of holes).

FIG. 2 presents SEM images of laser-perforated holes in carbon paper electrodes with an average of hole diameter of (a) 171 μm, (b) 234 μm, (c) 287 μm and (d) 421 μm.

FIG. 3 illustrates the spacing between holes for different hole densities: (a) 96.8, (b) 180, (c) 352.8, (d) 480.2 and (e) 649.8 holes cm⁻².

FIG. 4 presents (a) Polarization curves and measured ASR for perforated electrodes with varying hole size, and (b) extracted peak power and limiting current density values at a constant flow rate of 20 ml min⁻¹.

FIG. 5 presents (a) polarization curves and measured ASR for perforated electrodes with varying hole density (number of holes), and (b) extracted peak power and limiting current density values at a constant flow rate of 20 ml min⁻¹.

FIG. 6 presents polarization curves and corresponding ASR at various flow rates for Case 6 (hole diameter=234 μm, hole density=352.8 holes cm⁻²).

FIG. 7 presents peak power and limiting current as a function of the flow rate for the raw electrode and Case 6 (hole diameter=234 μm, hole density=352.8 holes cm⁻²).

FIG. 8 presents a depiction of accomplishing improved through-plane electrolyte delivery via use of perforations.

FIG. 9 illustrates that perforated electrodes show improved kinetics and mass transport versus the raw electrode.

FIG. 10 illustrates the need to balance large surface area with electrolyte accessibility.

FIG. 11 illustrates some of the different flow field geometries that can be utilized.

FIG. 12 shows that perforated electrodes exhibit improved performance versus a raw electrode for a single flow field.

FIG. 13 shows a comparison of performance as a function of flow rate.

FIG. 14 shows superior performance for serpentine and interdigitated flow fields.

FIG. 15 presents a summary of performance at 50 mL/min for each of four flow fields. In each bar pair, the perforated electrode data is to the right.

FIG. 16 compares pressure drop in both half-cells at 50 mL/min for both raw and perforated electrodes. In each bar pair, the perforated electrode data is to the right.

FIG. 17 presents an illustration of the effect of flow rate for serpentine and interdigitated flow fields.

### DETAILED DESCRIPTION OF ILLUSTRATIVE EMBODIMENTS

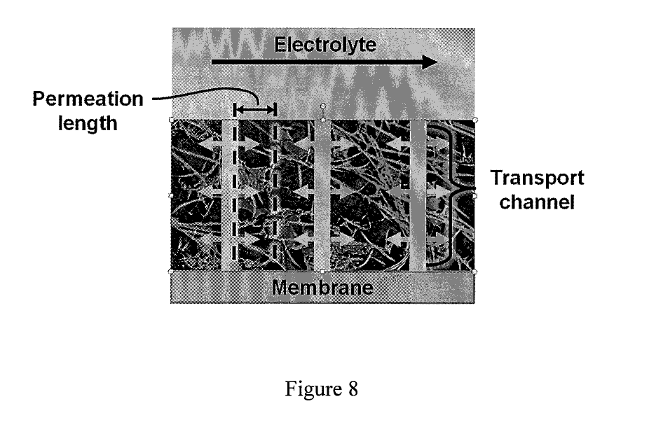

The present invention addresses mass transport limitations in electrode materials (such as carbon paper) that result from the underutilization of available surface area which results in limiting available power density. One method of accomplishing this illustrated by FIG. 8 where perforations (“transport channels”) are created to provide improved through-plane electrolyte delivery, and reduce permeation length.

In some embodiments, the invention concerns laser perforation techniques were developed which can be applied to porous electrodes for battery applications (flow battery applications, for example) to achieve high power performance. The perforation process creates holes of a well-defined, controllable size. These holes function as enhanced transport pathways for the reactants in the system, allowing the reactants to more rapidly penetrate the porous electrode structure during operation. The exact geometry of these patterns can be easily controlled, with resolution on the order of 20 micrometers. The perforation process can be further modified to create other geometric features, such as channels, depending on the specific application. It was observed that laser perforated electrodes provides significantly higher power density (˜30% increase) as compared to conventional non-perforated electrodes in flow battery operations.

Laser-perforation of the electrode is intended to enhance the mass transport (electrolyte transport for flow battery applications) within the materials. Enhanced electrolyte transport in these systems enables higher power densities and current densities to be achieved, resulting in improved performance. To date, we have demonstrated up to 30% improvement in power density, and 15% improvement in current density. These improvements were obtained using a common, commercially available electrode material as the base (non-perforated) material. The technique utilizes widely available laser (such as a CO₂ laser) cutting technology, so it can be immediately implemented into the flow battery manufacturing process without the need for extensive process development. The performance improvements observed from this technique could produce significant cost savings for flow battery manufacturers, who would be able to use a smaller system to satisfy the same user demands.

In addition to utilizing a laser to form holes or other perforations, other methods may be employed. Examples of forming such methods include punching, milling, drilling, electrical discharge machining, cutting and templating. These perforation techniques are well known in the art.

Any suitable porous electrode material may be utilized in the invention. Some preferred embodiments use a porous carbon paper electrode. Such non-perforated electrodes are known in the art and available commercially.

Flow batteries are well known in the art and utilize a variety of electrodes, electrolytes and separators. Properties and reviews on redox flow batteries include M. Skyllas-Kazacos, et al., Journal of the Electrochemical Society, 158 (2011) R55-R79, A. Parasuraman, et al., Electrochemica Acta, 101 (2013) 27-40, N. Trung and R. F. Savinell, Electrochemical Society Interface, 19 (2010) 54-56 and K. W. Knehr, et al., Journal of the Electrochemical Society, 159 (2012) A1446-A1459. One preferred redox flow battery is a vanadium redox flow battery.

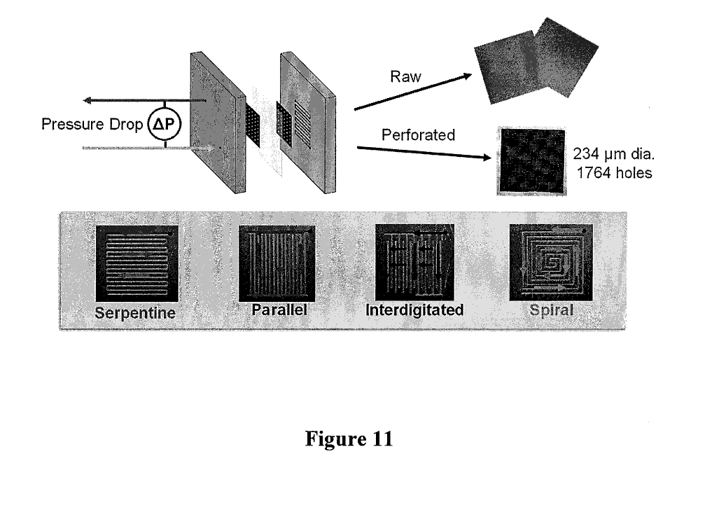

Any suitable flow field may be used with the instant perforated electrodes. Possible flow field geometries include serpentine, parallel, interdigitated and spiral and are illustrated in FIG. 11.

### EXAMPLES

### Electrolyte Preparation

The all-vanadium electrolyte was synthesized by dissolving vanadium (IV) oxide sulfate hydrate (VOSO₄.xH₂O, Sigma Aldrich) in a solution of sulfuric acid and deionized (DI) water. The final concentrations were 1 M vanadium and 5 M SO₄²⁻. From this starting solution, electrolyte in the fully charged state for the positive and negative half-cells (V(V) and (VII), respectively) were prepared using the electrochemical method described in E. Agar, C. R. Dennison, K. W. Knehr, E. C. Kumbur, Journal of Power Sources, 225 (2013) 89-94. During all tests, the electrolyte volumes in each negative and positive tank were 50 mL. The electrolyte tanks maintained a continuous nitrogen blanket above the electrolytes, and were purged with nitrogen prior to start of measurements in order to prevent oxidation of the vanadium species.

### Electrochemical Measurements

All performance measurements were performed using a Scribner Associates 857 Redox Flow Cell Test System. Polarization curves were recorded by applying a series of galvanostatic discharge steps, starting from ˜100% state-of-charge (SoC). The current steps were evenly spaced using 100 mA increments (20 mA cm⁻²) and lasted 30 seconds each to allow the system to stabilize. Discharge was terminated when the cell voltage dropped below 0.2 V. The charged state of the cell (˜100% SoC) was assumed to be reached after the charging current dropped below 10 mA (2 mA cm⁻²) while applying constant potential of 1.8 V to the cell. During all tests, the high-frequency resistance (HFR) was measured at a frequency of 10 kHz. The areal specific resistance (ASR) was calculated by multiplying the HFR and the electrode area (5 cm²).

### Laser-Perforation

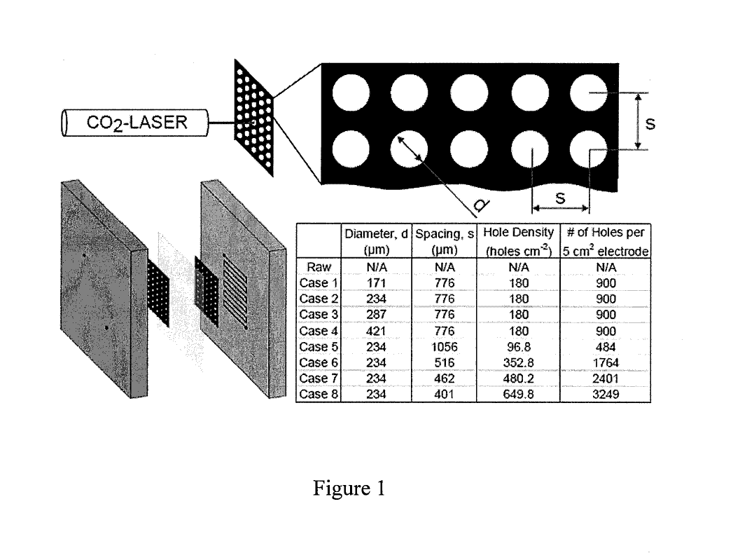

In order to determine the effects of laser perforation on electrode performance, 8 different perforation (also referred to simply as ‘holes’, for brevity) patterns were designed (see FIG. 1). Cases 1 through 4 had a constant hole density of 900 holes per 5 cm² electrode (180 holes cm⁻²) with hole diameters varying from 171 to 421 μm. Cases 5 through 8 had a nominal hole diameter of 234 μm and a hole density ranging from 484 to 3249 holes per 5 cm² electrode (96.8 to 649.8 holes cm⁻²). These configurations were selected to study the effects of hole diameter (Cases 1 through 4) and hole density (Cases 5 through 8) on the system performance. A schematic and summary of all Cases tested are provided in FIG. 1.

For each case, the perforations were made in a Cartesian grid-pattern. For this reason, the total number of holes per 5 cm² electrode was constrained to square numbers (e.g., 484 holes per 5 cm² electrode corresponds to a 22×22 grid). As a raw electrode material, non-perforated SGL 10AA carbon paper was chosen because it has the highest reported power density to-date (Q. H. Liu, G. M. Grim, A. B. Papandrew, A. Turhan, T. A. Zawodzinski, M. M. Mench, Journal of the Electrochemical Society, 159 (2012) 1246-1252). Raw SGL 10AA was characterized and considered as the baseline case to compare the laser-perforated electrodes against. In all cases, the material was used as-received, without any form of pre-treatment.

Perforation of the raw material was performed using an EPILOG mini 45 watt CO₂ laser cutting machine. During cutting, a sheet of carbon paper was fixed to a graphite backing plate with tape in order to ensure a flat surface during cutting and thus a well-focused laser beam. The cutting process was performed twice to ensure that the laser penetrated the material completely and a clean cut without residues was achieved. The laser perforation process was quite rapid: more than 50,000 individual perforations could be produced approximately 1.5 hours, which is equivalent 20 or more of the electrodes used in this study (depending on the complexity of the pattern). Fairly conservative laser cutting parameters (e.g. laser power, raster speed, etc.) were used to manufacture the electrodes in this study. In practice, the cutting time could be significantly reduced by using a higher powered laser and optimizing the cutting parameters.

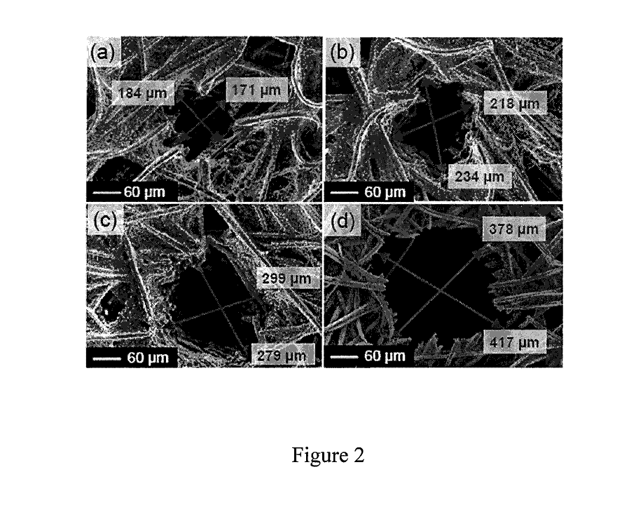

FIG. 2 shows a typical hole at each selected diameter value. The images were taken with a Carl Zeiss Supra 55 scanning electron microscope (SEM). All diameter values used in this study are an average of spatial measurements determined from the SEM micrographs. The observed holes are not perfectly circular in shape. This is likely due to the limited spatial resolution of the laser cutting machine, errors in beam focusing, and the varying density of the carbon paper. The standard deviation observed at each hole diameter is 18, 32, 47, and 25 μm for electrodes with nominal diameters of 171, 234, 287, and 421 μm, respectively.

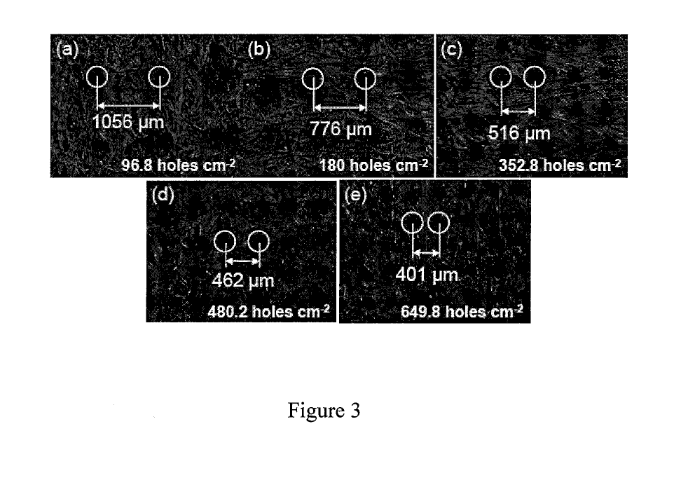

FIG. 3 shows the spacing between the laser-perforated holes for varying hole densities (number of holes per electrode). The spacing measurements were performed using a Nikon ECLIPSE ME600 microscope, and the images shown were taken on a Nikon SMZ800 stereo microscope. The spacing between holes was found to be quite uniform for all samples examined

### Results and Discussion

### Role of Perforation Size on VRFB Performance

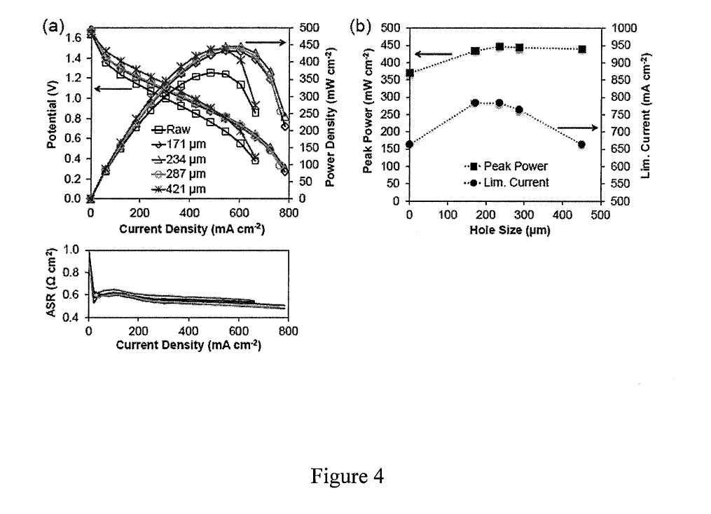

The first set of laser perforated electrodes tested (Cases 1-4) with hole sizes ranging from 171 to 421 μm in diameter at a constant hole density of 180 holes cm⁻² (900 holes per 5 cm² electrode). In order to determine the effect of perforation diameter, polarization curves for each electrode were recorded at a flow rate of 20 mL min⁻¹. The polarization curves are shown in FIG. 4a, and the peak power density and limiting current density extracted from these plots are shown in FIG. 4b. Additionally, the primary measures of performance for each case are listed in Table 1.

TABLE 1
Performance metrics for electrodes with various diameter laser
performations at a constant hole density of 180 holes cm⁻².

| | | | | Limiting | | | |
|---|---|---|---|---|---|---|---|
| | | | | Current | | | |
| | | | Area | Density at | Peak | Change in | |
| | Hole | | Specific | 20 mL min⁻¹ | Power | Surface | Approx. |
| Case | Diameter | OCV | Resistance | Flow Rate | Density | Area vs. Raw | Porosity |
| Number | (μm) | (V) | (mΩ cm²) | (mA cm⁻²) | (mW cm⁻²) | (%) | (%) |
| Raw | N/A | 1.64 | 537-615 | 663 | 369 | 0 | 88 |
| 1 | 171 | 1.68 | 507-633 | 783 | 434 | −4 | 84 |
| 2 | 234 | 1.67 | 479-600 | 783 | 447 | −8 | 81 |
| 3 | 287 | 1.66 | 490-606 | 763 | 443 | −12 | 78 |
| 4 | 421 | 1.64 | 545-647 | 663 | 440 | −25 | 66 |

From the results (FIG. 4a), it is observed that the laser-perforated electrodes exhibit increased average voltage and power density compared to the raw material. The electrode with 234 μm hole diameter shows the highest peak power density of 447 mW cm⁻², while the electrodes with smaller and larger diameter holes exhibit slightly lower peak power densities (FIG. 4b). In comparison to this, the raw electrode shows a much lower peak power density of only 369 mW cm⁻². All electrodes tested show a consistent ASR around 0.6Ω cm², which is comparable to previously reported results for carbon paper electrodes.

When the polarization curves for the laser-perforated electrodes (FIG. 4a) are analyzed, an improvement in the kinetic region of the polarization curve (˜0-100 mA cm⁻²) is observed, which scales with increasing hole diameter. This improvement is likely due to the local surface functionalization of the material surrounding each hole. It has been shown that the presence of a ‘heat affected zone’ (HAZ) around laser-perforations in a similar carbon paper material (SGL 10BB) commonly used in PEM fuel cell applications. This HAZ was observed to extend ˜200 μm radially from the center of the hole. It was reported that PTFE (found in the virgin electrode material used in the study) was largely removed in the HAZ, indicating that the area reached a temperature sufficient to decompose PTFE (>350° C.). Liu et al. have demonstrated that SGL 10AA carbon paper can be thermally treated at similar temperatures (400° C.) in an air atmosphere, providing a noticeable improvement in peak power and limiting current density. Based on these previous observations, it is plausible that the material surrounding the perforations in the present study was effectively ‘thermally treated’ in a similar manner to Liu et al. (Q. H. Liu, G. M. Grim, A. B. Papandrew, A. Turhan, T. A. Zawodzinski, M. M. Mench, Journal of the Electrochemical Society, 159 (2012) 1246-1252), giving rise to the observed improvement in the kinetic region.

In addition to the improved performance in the activation region, the observed improvements in limiting current and power density are also attributed to increased accessibility of active surface area in the perforated electrodes. In FIG. 4a, this is indicated by the delayed downward deflection of the polarization curve at higher current densities, indicating improved mass transport in the electrodes. It is interesting to note that the limiting current density (FIG. 4b) is significantly increased for the perforated electrodes with hole diameters up to 287 μm, even though the total active surface area of these electrodes is decreased by 4% (for hole diameter ø=171 μm), 8% (ø=234 μm) and 12% (ø=287 μm) due to laser-perforation. However, although the electrode with the largest perforations (ø=421 μm) shows a very respectable power density of 440 mW cm−2 at low current densities (<500 mA cm−2), a rapid decrease in voltage occurs above 500 mA cm−2, resulting in a limiting current similar to the raw electrode. These results suggest a tradeoff between mass transport and available surface area in these carbon paper electrodes. The apparent peak in limiting current between 171 and 234 μm hole diameter observed in FIG. 4b indicates a substantial mass-transport limitation in the raw material. When the data is compared for different electrode configurations, the introduction of laser-perforations seems to improve the ability of the electrolyte to access the available surface area in the electrodes, leading to an increase in the limiting current density. However, laser perforation removes a portion of the available surface area (Table 1). As the perforations increase in diameter, electrolyte accessibility appears to be improved at the expense of available surface area. Therefore, the electrode with the largest perforations (ø=421 μm) is likely limited by the total surface area remaining after perforation, rather than the electrolyte accessibility.

### Role of Perforation Density on VRFB Performance

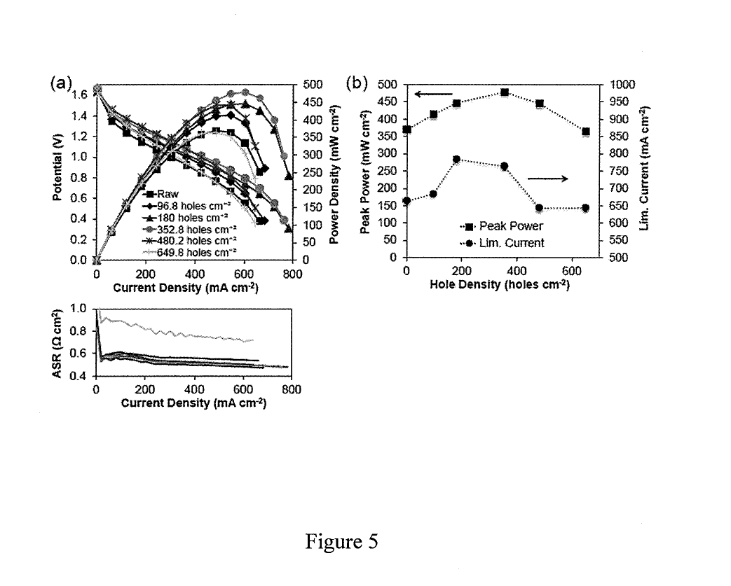

A second set of electrodes (Cases 2, 5-8) with a varying density (number) of holes ranging from 484 to 3249 holes per 5 cm² electrode (96.8 to 649.8 holes cm⁻²) were tested to investigate the effect of hole density on device performance. Although a specific number of holes were specified for each electrode in this study, hole density values (holes cm⁻²) are used here to provide a normalized value, which can be extended to systems of varying size. Changing the hole density not only affects the total number of transport channels available for mass transport, it also affects the distance that electrolyte must travel into the bulk of the electrode. The hole spacing (center-to-center) is provided as an indicator of the distance that electrolyte has to travel between holes (see Table 2). As the spacing between holes decreases, mass transport is expected to improve because electrolyte does not need to travel as far to fully access the available surface area. Based on the previous tests, a hole diameter of 234 μm was chosen as the standard hole size for these Cases, as this diameter was observed to provide the highest power density of the hole sizes tested (see FIG. 4b). The results of these tests are shown in FIG. 5.

TABLE 2
Performance metrics for electrodes with different number of holes per
electrode (i.e., hole density) at a constant hole diameter of 234 μm.

| | | | | | Limiting | | | |
|---|---|---|---|---|---|---|---|---|
| | | | | | Current | | | |
| | | | | Area | Density at | Peak | Change in | |
| | Hole | Hole | | Specific | 20 mL min⁻¹ | Power | Surface Area | Approx. |
| Case | Density | Spacing | OCV | Resistance | Flow Rate | Density | vs. Raw | Porosity |
| Number | (holes cm⁻²) | (μm) | (V) | (mΩ cm²) | (mA cm⁻²) | (mW cm⁻²) | (%) | (%) |
| Raw | N/A | N/A | 1.64 | 537-615 | 663 | 369 | 0 | 88 |
| 5 | 96.8 | 1056 | 1.64 | 472-561 | 683 | 413 | −4 | 84 |
| 2 | 180 | 776 | 1.67 | 479-600 | 783 | 447 | −8 | 81 |
| 6 | 352.8 | 516 | 1.66 | 475-578 | 763 | 478 | −15 | 75 |
| 7 | 480.2 | 462 | 1.63 | 498-579 | 643 | 445 | −21 | 70 |
| 8 | 649.8 | 401 | 1.63 | 703-922 | 643 | 364 | −28 | 63 |

As in the previous test series, all of the laser-perforated electrodes demonstrate improved performance in the activation region of the polarization curve (FIG. 5a). As stated earlier, this is believed to be caused by the localized thermal treatment of the fibers directly surrounding the holes due to heat generated during the laser perforation. However, only the electrodes with 180 and 352.8 holes cm⁻² (i.e., 900 and 1764 holes per 5 cm² electrode, respectively) exhibit a substantial improvement in the mass-transport region (i.e., high current densities). As seen in FIG. 5b, the limiting current for these intermediate hole-density electrodes is observed to be significantly higher than the other cases tested, indicating a good balance of electrolyte accessibility and surface area remaining after perforation. On the other hand, the electrode with the fewest perforations (i.e., 96.8 holes cm⁻²-484 holes per 5 cm² electrode) is still likely limited by the ability of the electrolyte to access to all of the available surface area. Conversely, the electrodes with the most perforations (i.e., 480.2 and 649.8 holes cm⁻²-2401 and 3249 holes per 5 cm² electrode, respectively) appear to be limited by the overall electrode surface area, rather than electrolyte accessibility.

In terms of power density, as the hole density was increased from 96.8 to 352.8 holes cm−2 (484 to 1764 holes per 5 cm² electrode, respectively), the power density was found to increase to a maximum of 478 mW cm⁻², compared to 369 mW cm−2 for the raw electrode (FIG. 5b). For the case with 352.8 holes cm⁻², this corresponds to an increase in peak power of 30% versus the raw electrode. However, beyond 352.8 holes cm⁻², the creation of additional perforations was seen to decrease the power density. In fact, the performance of electrode with 649.8 holes cm⁻² (3249 holes per 5 cm² electrode) falls below the peak power density and limiting current of the raw electrode. Similar to the hole diameter study, the reason for this decrease is believed to be the excessive amount of surface area lost due to perforation.

Additionally, the electrode with 649.8 holes cm⁻² (3249 holes per 5 cm² electrode) was observed to be visibly thinner and more flexible than all other electrodes tested. The large amount of material removed during laser-perforation (˜28% material loss) is believed to have decreased the stability of the carbon paper, resulting in a lower compression pressure under normal assembly and greater ASR due to increased contact resistance. While the average ASR for most of the electrodes studied was below 0.6Ω cm², the ASR for the electrode with 649.8 holes cm⁻² was observed to be significantly higher (˜0.8Ω cm²).

### Role of Flow Rate on the Performance of Perforated Electrodes

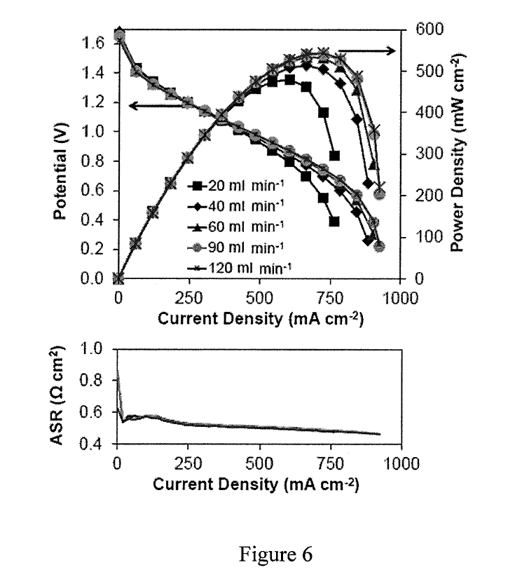

In order to better understand the role of perforations on mass transport within the electrode, the effect of flow rate was also investigated. Based on the previous results, the best-performing electrode at a flow rate of 20 mL min⁻¹ was found to be Case 6 (ø=234 μm and 352.8 holes cm⁻²). Polarization curves for this electrode were conducted at flow rates of 40, 60, 90 and 120 mL min⁻¹ to further highlight the benefits of laser perforations for improving mass transport in the cell. The results are shown in FIG. 6.

As shown in FIG. 6, all tested cases follow the same trend below 500 mA cm⁻². At 20 ml min⁻¹, the onset of mass transport limitations appears to begin around 500 mA cm⁻², whereas for the other flow rates tested, the mass transport limitation appears to start around 625-650 mA cm⁻². When the overall trend is analyzed, the mass transport losses seem to be improved with increasing flow rate for the tested perforated electrode. As expected, higher flow rates lead to incremental improvements in performance at higher current densities, although the difference in performance between 90 and 120 mL min⁻¹ is small. The ASR was observed to remain between 0.5 and 0.6Ω cm² for all tests.

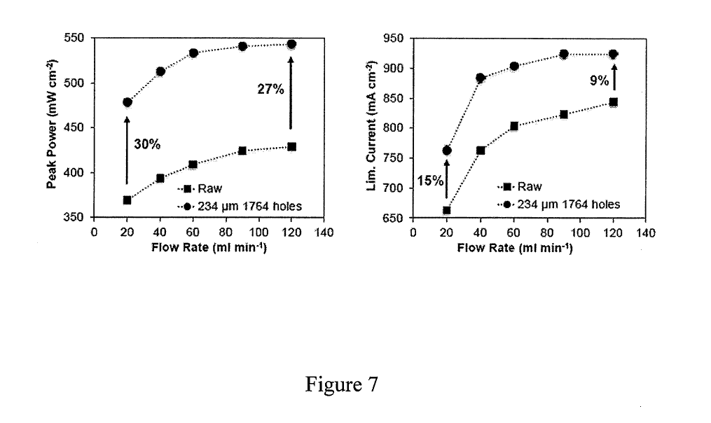

FIG. 7 shows the peak power and the limiting current density of our best performing electrode (hole diameter of 234 μm and 352.8 holes cm⁻²) compared to the raw electrode at various flow rates. For the highest tested flow rate of 120 mL min⁻¹, the peak power for the raw electrode was around 429 mW cm⁻², while the perforated electrode exhibited 543 mW cm⁻² (27% higher than the raw electrode). At a more conventional flow rate of 20 mL min⁻¹, the peak power is observed to increase from 369 mW cm⁻² for the raw electrode, whereas for the perforated electrode, it goes up to 478 mW cm⁻² (30% increase). Similarly, the limiting current densities at 20 mL min⁻¹ are found to increase from 663 mA cm⁻² for the raw electrode to 763 mA cm⁻² (for perforated electrodes (15% increase). At 120 mL min⁻¹, the raw electrode demonstrated 844 mA cm⁻² while the perforated electrode produced 924 mA cm⁻² (9% increase). Based on these results, it appears that the effectiveness of the laser perforations is not diminished at higher flow rates. This indicates that mass transport within the raw carbon paper electrodes is consistently limited, even at higher flow rates when more advantageous concentration and pressure gradients are present.

It is worth pointing out that at a flow rate of 90 mL min⁻¹, the raw SGL 10AA electrode was observed to deliver 424 mW cm⁻². Under similar conditions, however, Aaron et al. were able to reach a peak power of 557 mW cm⁻² (D. S. Aaron, Q. Liu, Z. Tang, G. M. Grim, A. B. Papandrew, A. Turhan, T. A. Zawodzinski, M. M. Mench, Journal of Power Sources, 206 (2012) 450-453). The lower absolute power density observed in this study is believed to be due to variations in the experimental setup. Nonetheless, similar relative improvements (up to 30%) are expected when implementing these laser perforated electrodes into more optimized cells, leading to even higher absolute power- and limiting current densities than are reported here.

In this study, the performance of a VRFB was investigated using raw and laser-perforated SGL 10AA carbon paper electrodes in a zero-gap serpentine flow field cell design. The carbon paper electrodes were laser-perforated in order to create ‘transport channels’ for improved mass transport within the electrode. The laser perforation process was quite efficient: more than 50,000 individual perforations could be produced approximately 1.5 hours, which is equivalent 20 or more of the electrodes used in this study (depending on the complexity of the pattern). In this work, three parameters were studied: hole size (diameter), hole density (number of holes per cm²), and flow rate. By testing a series of electrodes with different hole diameters and hole densities, a maximum power density of 478 mW cm⁻² was achieved using an electrode with 234 μm diameter holes at a hole density of 352.8 holes cm⁻² (1764 holes per 5 cm² electrode) and flow rate of 20 mL min⁻¹ This corresponds to a 30% increase in power density compared to the raw, un-perforated material (369 mW cm⁻²). Similarly, the limiting current for this perforated electrode exhibited a 15% increase (763 mA cm⁻²) compared to the raw electrode (663 mA cm⁻²).

Despite a loss in total surface area, the improved performance of the modified electrode is largely attributed to the increased mass transport ability provided by the laser perforations, which act as pathways for the electrolyte to better penetrate the electrode. However, excessive perforation of the electrode may reduce both power density and limiting current density due to the significant loss of surface area. The laser perforated electrodes were also observed to have better performance in the activation region of the polarization curve. This improvement is believed to be due to the localized heating of the fibers surrounding the holes during perforation, which improves the kinetics of the electrodes.

Additionally, the effect of perforation on battery performance was studied at different flow rates. Results show that the addition of perforations improves power and current density over a wide range of flow rates. At a flow rate of 120 mL min⁻¹, a maximum power density of 543 mW cm⁻² was achieved. Compared to the raw material (429 mW cm⁻² at 120 mL min⁻¹), this is an increase of 27%. However, slightly larger improvements (up to 30% at 20 mL min⁻¹) were observed for perforated electrodes at lower flow rates, when the system is more prone to mass transport limitations and these ‘transport channels’ are even more critical.

Results of this study show that the use of laser-perforated electrodes in an optimized configuration increases the performance of a VRFB (up to 30% in this study) compared to raw carbon paper, despite a significant loss in the total active surface area (15% for the highest performing electrode in this study) due to the laser-perforation. These findings highlight the fact that by proper tailoring the transport pathways in the electrode structure, it is possible to further enhance the power density of the electrodes used in these systems.

Effect of Perforations and their Diameter and Density

FIG. 8 presents a depiction of accomplishing improved through-plane electrolyte delivery via use of perforations. Transport channels reduce permeation length, thereby improving through-plane delivery.

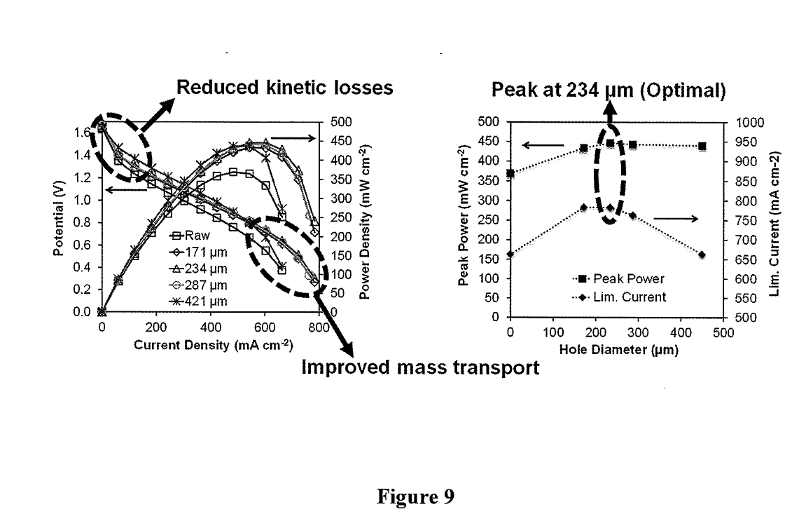

The effect of perforation diameter was explored. Results are presented in FIG. 9 which illustrates that perforated electrodes show improved kinetics and mass transport versus the raw electrode.

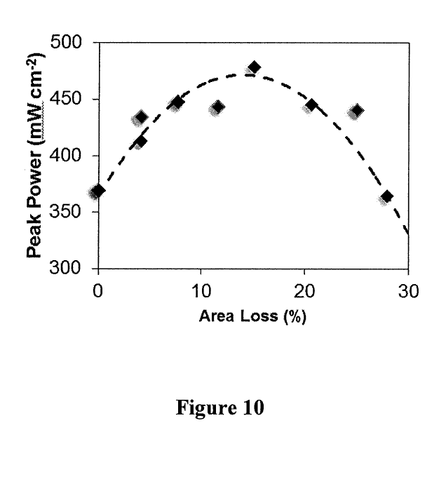

FIG. 10 illustrates the need to balance large surface area with electrolyte accessibility. Results from varying hole diameter and hole density are presented in Table 3.

TABLE 3
Variation of hole diameter and hole density.
Varying diameter:

| | Hole | Peak Power | Change in Surface | Approx. |
|---|---|---|---|---|
| Case | Diameter | Density | Area vs. Raw | Porosity |
| Number | (μm) | (mW cm⁻²) | (%) | (%) |
| Raw | N/A | 369 | 0 | 88.0 |
| 1 | 171 | 434 | −4 | 88.5 |
| 2 | 234 | 447 | −8 | 88.9 |
| 3 | 287 | 443 | −12 | 89.4 |
| 4 | 421 | 440 | −25 | 91.0 |

Varying hole density:

| | Hole | Peak Power | Change in Surface | Approx. |
|---|---|---|---|---|
| Case | Density | Density | Area vs. Raw | Porosity |
| Number | (holes cm⁻²) | (mW cm⁻²) | (%) | (%) |
| Raw | N/A | 369 | 0 | 88.0 |
| 5 | 96.8 | 413 | −4 | 88.5 |
| 2 | 180 | 447 | −8 | 88.9 |
| 6 | 352.8 | 478 | −15 | 89.8 |
| 7 | 480.2 | 445 | −21 | 90.5 |
| 8 | 649.8 | 364 | −28 | 91.4 |

### Flow Fields

FIG. 11 illustrates some of the different flow field geometries that can be utilized. Possible flow field geometries include serpentine, parallel, interdigitated and spiral.

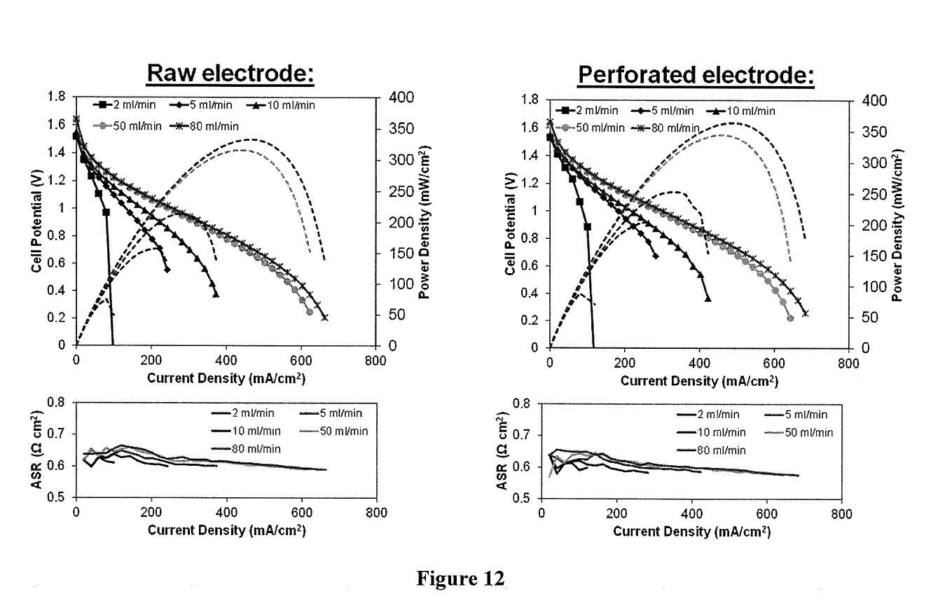

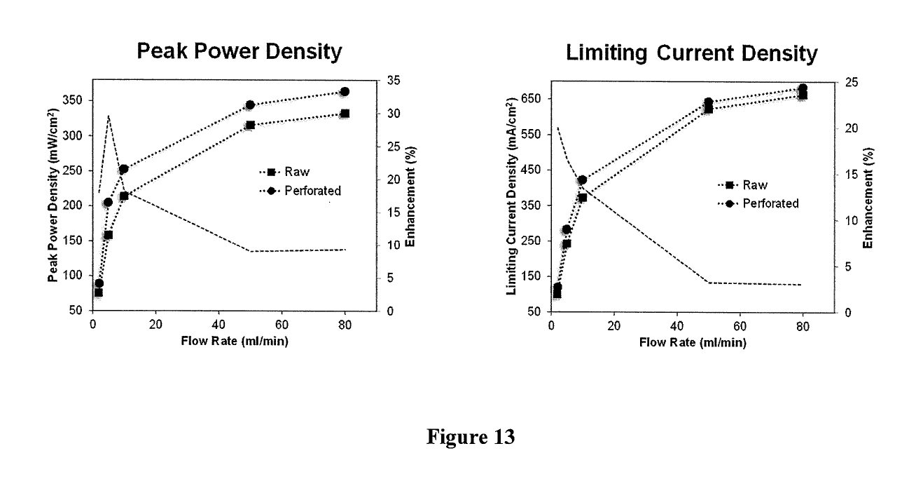

FIG. 12 shows that perforated electrodes exhibit improved performance versus a raw electrode for a single flow field. FIG. 13 shows a comparison of performance as a function of flow rate. Both peak power and limiting current are considerably enhanced for perforated electrodes—especially at low flow rates.

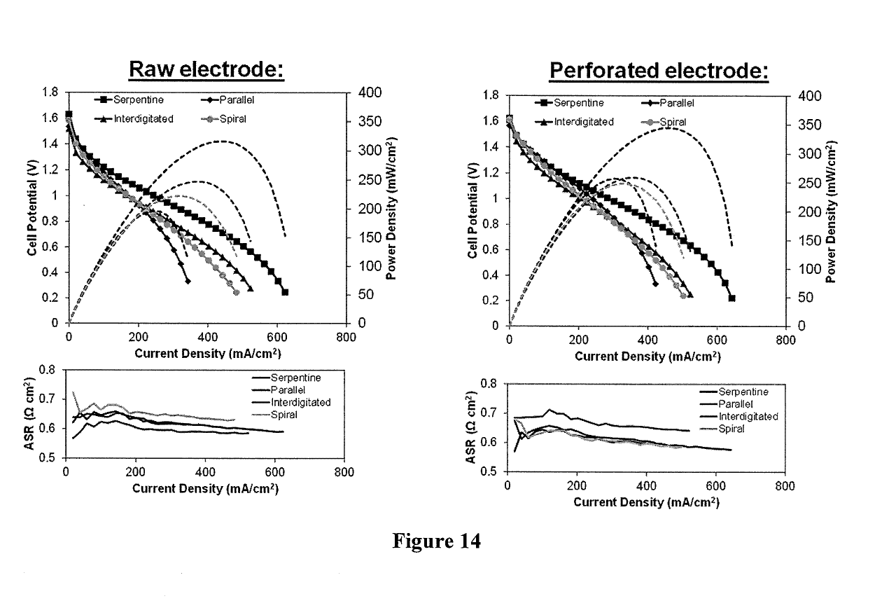

FIG. 14 shows the highest performance for serpentine and interdigitated flow fields.

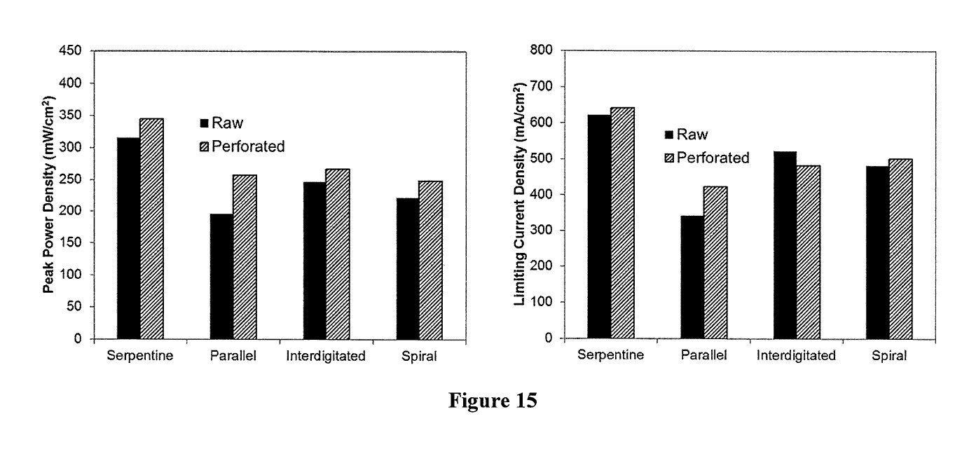

FIG. 15 presents a summary of performance at 50 mL/min for each of four flow fields. Perforated electrodes consistently improve peak power and limiting current performance, regardless of design. In each bar pair, the perforated electrode data is to the right.

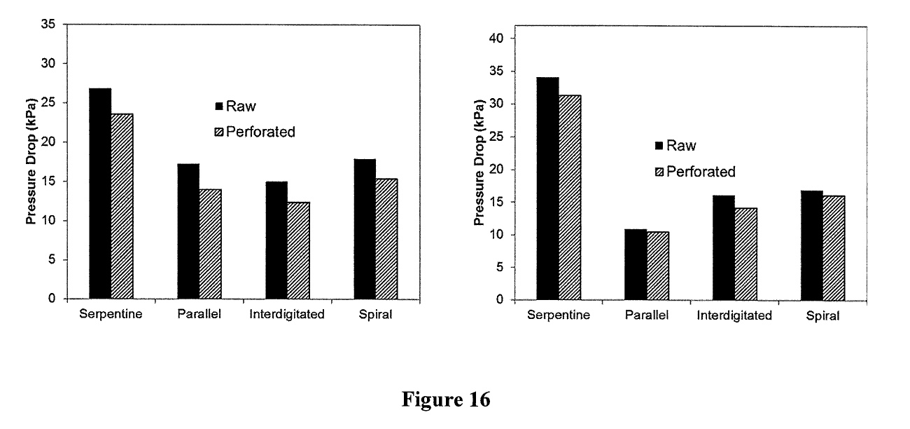

FIG. 16 compares pressure drop in both half-cells at 50 mL/min for both raw and perforated electrodes. Perforated electrodes reduce the total pressure drop in all cased. In each bar pair, the perforated electrode data is to the right.

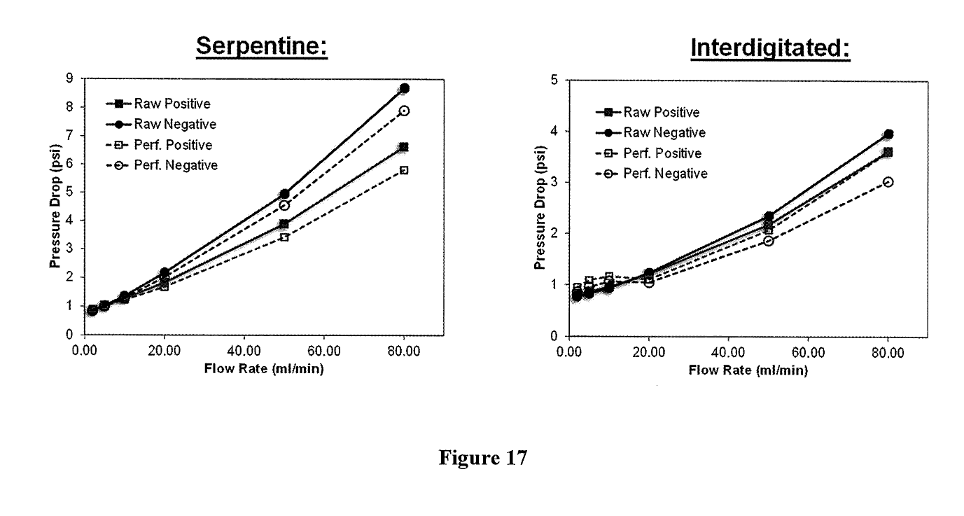

FIG. 17 presents an illustration of the effect of flow rate for serpentine and interdigitated flow fields—the fields that exhibited the best performance.

### Certain Observations

Creation of laser perforated ‘transport channels’ can yield significant performance improvements for carbon paper electrodes. These improvements were observed in all flow field geometries tested, particularly at low flow rates. Peak power increased up to 30% compared to raw electrode material. Limiting current increased up to 15% despite a net reduction in surface area. Pressure drop is also reduced by using perforated electrodes. The results highlight the need for high surface area electrodes with tailored mass transport pathways for improved electrolyte delivery.

What is claimed:

1. An electrode suitable for use in a redox flow battery, said electrode comprising a porous electrode having a plurality of perforations, said perforations ranging in diameter from 100 μm to 10 cm.

2. The electrode of claim 1, wherein said electrode has a perforation density of from 10 to 5,000 (holes cm⁻²).

3. The electrode of claim 1, wherein said perforation is a hole, slits, channels, or void.

4. The electrode of claim 3, wherein said holes have a diameter from 150 μm to 1 cm.

5. The electrode of claim 1, wherein said porous electrode comprises carbon paper.

6. The electrode of claim 1, wherein said porous electrode comprises multiple sheets of paper having a plurality of holes.

7. The electrode of claim 5, wherein said perforations of the multiple sheets of porous paper are substantially in alignment between said sheets of paper.

8. A flow battery comprising
a first half-cell comprising:
a first electrolyte comprising a first redox active material;
a first electrode in contact with said first electrolyte; and
a first current collector in contact with said first electrode; and
a second half-cell comprising:
a second electrolyte comprising a second redox active material; and
a second electrode in contact with said second electrolyte; a second current collector in contact with said second electrode; and
a separator disposed between said first half-cell and said second half-cell;
wherein at least one of said first or second electrodes is an electrode of claim 1.

9. The flow battery of claim 8, wherein said electrode has a perforation density of from 10 to 5,000 (holes cm⁻²).

10. The flow battery of claim 8, wherein said perforation is a hole, slits, channels, or void.

11. The flow battery of claim 10, wherein said holes have a diameter from 150 μm to 1 cm.

12. The flow battery of claim 8, wherein said porous electrode comprises carbon paper.

13. The flow battery of claim 8, wherein said porous electrode comprises multiple sheets of paper having a plurality of holes.

14. The flow battery of claim 11, wherein said perforations of the multiple sheets of porous paper are substantially in alignment between said sheets of paper.

15. The flow battery of claim 8, having at least a 10% increase in power density compared to an electrode lacking said plurality of perforations.

16. The flow battery of claim 1 having a flow associated with at least one of the first and second electrodes is serpentine, parallel, interdigitated or spiral.

17. A method of forming an electrode suitable for use in a redox flow battery, said method comprising forming a plurality of holes in a porous electrode, said holes ranging in diameter from 100 μm to 10 cm.

18. The method of claim 17, wherein said plurality of holes are formed utilizing a laser, punching, milling, drilling, electrical discharge machining, cutting or templating.

19. The method of claim 17, wherein said plurality of holes are formed utilizing a laser.

20. The method of claim 17, wherein said porous electrode comprises carbon paper.

21. The method of claim 17, wherein said holes ranging in diameter from 150 μm to 1 cm.

22. The method of claim 17, wherein said electrode having a hole density of 10 to 5,000 (holes cm−2).
